(19) United States
(12) Patent Application Publication
(10) Pub. No.: US 2023/0169596 A1
(43) Pub. Date: Jun. 1, 2023

(54) SYSTEMS AND TECHNIQUES FOR AUTHENTICATING INSURANCE CLAIMS

(71) Applicant: Capital One Services, LLC, McLean, VA (US)

(72) Inventors: Jeffrey RULE, Chevy Chase, MD (US); Paul MORETON, Glen Allen, VA (US)

(73) Assignee: Capital One Services, LLC, McLean, VA (US)

(21) Appl. No.: 17/538,622

(22) Filed: Nov. 30, 2021

(51) Int. Cl. G06Q 40/08; G06F 21/44; H04W 4/80

(52) U.S. Cl. CPC G06Q 40/08; G06F 21/44; H04W 4/80

(57) ABSTRACT

Disclosed are a computing apparatus, a computer-readable storage medium, a system and a method that enable authentication of a claim request. An insurance provider application receive a claim request message related to an insured object. Encrypted information enabling authentication may be obtained from a user identifier apparatus of the user associated with the insured object. The information may include a reference link to an authentication application and multiple parameters. State information related to insured object and a mobile device associated with the insured object may be retrieved. The user of the insured object may be authenticated based on one or more of the multiple parameters by the authentication application. Confirmation that the retrieved state information corresponds to the insured object may be received. Based on an evaluation of the confirmation and a response to the request for authentication, processing of the claim request message may proceed.

### BACKGROUND

Identity theft is often a first crime that leads to other crimes such as insurance fraud, bank fraud, tax return fraud and the like involving the stolen identity. In the case of insurance fraud, using the stolen identity, thieves fraudulently obtain insurance policies for automobiles, homes or rental units, and make fraudulent claims.

Examples of insurance fraud includes misrepresenting facts on insurance applications and inflating insurance claims. In cases of automobile insurance, the bad actors may take extraordinary measures such as staging accidents and submitting claim forms for injuries or damage that never occurred. Moreover, the bad actors may obtain images of accidents from the internet, manipulate the images, and submit the images with an insurance claim for damage to a fake vehicle that was never owned by the identity theft victim.

As the bad actors may continue to obtain information of the victim of the identity theft from online databases, the ability of insurance providers to confirm the identity of the insured and the veracity of the submitted information becomes more difficult.

As such, it would be beneficial if a more robust identity regime may be implemented to authenticate the identity of the insured and the veracity of submitted claims.

### BRIEF SUMMARY

In one aspect, a computing apparatus is provided that includes a processor, a memory storing instructions and an insurance provider application. When the instructions and the insurance provider application are executed by the processor, the apparatus is operable to receive a claim request message via a user input related to an insured object of a user. The claim request message may be a message that includes insured object information. The processor may obtain, via a reading of a user identifier apparatus by a near-field communication circuit, information enabling authentication of the user as being associated with the insured object. The obtained information from the reading of the user identifier apparatus includes a reference link to an authentication application and multiple parameters. The processor may be operable to retrieve state information related to insured object and a mobile device associated with the insured object and send to the authentication application using the reference link, a request to authenticate the user of the insured object, where the request includes one or more of the multiple parameters. Confirmation that the retrieved state information corresponds to identifying information corresponding to the insured object may be received by the processor. The retrieved state information and a response to the request for authentication may be evaluated by the processor, and based on a result of the evaluation, proceed with processing of the claim request message by the insurance provider application.

In another aspect, a non-transitory computer-readable storage medium is provided. The computer-readable storage medium may include instructions that when executed by a processor, cause the processor to receive, by an insurance provider application, a claim request message via a user input related to an insured object of a user. The claim request message may be a message that includes insured object information. The processor may be caused to obtain, via a reading of a user identifier apparatus by a near-field communication circuit, information enabling authentication of the user as being associated with the insured object. The obtained information from the reading of the user identifier apparatus may include a reference link to an authentication application and multiple parameters. State information related to insured object and a mobile device associated with the insured object may also be retrieved. Using the reference link, a request to authentication of the user of the insured object is sent and the request includes one or more of the multiple parameters. Confirmation may be received that the retrieved state information matches to identifying information corresponding to the insured object. The retrieved state information may be evaluated and a response to the request for authentication, and based on a result of the evaluation, the processor may proceed with processing of the claim request message by the insurance provider application.

In a further aspect, a method is provided that includes receiving, by an insurance provider application, a claim request message via a user input related to an insured object of a user. The claim request message may be a message that includes insured object information. Information enabling authentication of the user as being associated with the insured object may be obtained via a reading of a user identifier apparatus by a near-field communication circuit. The obtained information from the reading of the user identifier apparatus may include a reference link to an authentication application and multiple parameters. State information related to insured object and a mobile device associated with the insured object may be retrieved. Using the reference link, a request for authentication of the user of the insured object is sent to the authentication application and the request includes one or more of the multiple parameters. Confirmation that the retrieved state information corresponds to identifying information corresponding to the insured object may be received. The confirmation of the retrieved state information and a response to the request for authentication may be evaluated. Based on a result of the evaluation, processing of the claim request message by the insurance provider application may proceed.

### BRIEF DESCRIPTION OF THE DRAWINGS

Throughout the drawings, it should be noted that like reference numbers are used to depict the same or similar elements, features, and structures.

FIG. 1 illustrates a functional block diagram of a system operable to implement the disclosed subject matter.

FIG. 2 illustrates a flowchart of an example process for authenticating a request according to the disclosed subject matter.

FIG. 3 illustrates a communication flow diagram in accordance with an example of the disclosed subject matter.

FIG. 4 illustrates an example of a contactless card usable in the examples described herein.

FIG. 5 illustrates additional features of the example contactless card of FIG. 4.

FIG. 6 illustrates an example of a computing architecture operable to implement one or more of the techniques and processes discussed with reference to the examples of FIGS. 1-5.

FIG. 7 illustrates an example of a mobile device usable for implementing the techniques and processes discussed with reference to the examples of FIGS. 1-5.

### DETAILED DESCRIPTION

Multifactor authentication may be used to reduce the number of false insurance claims that are filed. One form of multifactor authentication may involve using different entities to cross identify or verify an identity of a person. For example, a first entity, such as an insurance provider, may ask a user for additional information that is related to a second entity, such as a financial institution, that the first entity is aware that is used by the user.

An advantage provided by the disclosed fraud detection and elimination system is that by requesting additional information related to a claim request message and an insured object is that many fraudulent actors are unable or unwilling to provide the additional information which diminishes the likelihood of being successful in the submission of a fraudulent claim.

A further advantage is when the additional information provides additional objective evidence that the insured object suffered damage and the use of the additional objective evidence provides other avenues of authentication of the claim request message as being legitimate. Objective evidence may, for example, be an authenticatable identification card such as, for example, a government issued card (e.g., driver's license), a contactless credit card, a “smart” entity-specific card, or the like. An entity-specific card may be an insurance-provider card, an affinity card, manufacturer-provided card, or the like. A “smart” card may be similar to the contactless credit card that is described with reference to several of the figures and examples in this specification.

Advantageously, the capability to receive authenticatable objective evidence improves the security of all devices and associated data as well as the legitimacy of the underlying transaction, such as a fraud claim. For example, conventional approaches to providing the objective evidence require the user to manually enter the information, such as identification card data into an electronic form. However, doing so may allow other users or devices to capture the identification card data or enables a fraudulent user to enter stolen identification card information, as the user enters the identification card data into the form. By eliminating the need for the user to manually enter identification card data into the form, the security of the identification card data is enhanced. Furthermore, the cryptographic validation performed by the server provides an additional safeguard to ensure that the correct identification card data is being entered into the form. Additionally, the protects the security of the user, as conventional solutions require providing the actual account number of the contactless card into the form.

With general reference to notations and nomenclature used herein, one or more portions of the detailed description which follows may be presented in terms of program procedures executed on a computer or network of computers. These procedural descriptions and representations are used by those skilled in the art to convey the substances of their work most effectively to others skilled in the art. A procedure is here, and generally, conceived to be a self-consistent sequence of operations leading to a desired result. These operations are those requiring physical manipulations of physical quantities. Usually, though not necessarily, these quantities take the form of electrical, magnetic, or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, these manipulations are often referred to in terms, such as adding or comparing, which are commonly associated with mental operations performed by a human operator. However, no such capability of a human operator is necessary, or desirable in most cases, in any of the operations described herein that form part of one or more examples. Rather, these operations are machine operations. Useful machines for performing operations of various examples include digital computers as selectively activated or configured by a computer program stored within that is written in accordance with the teachings herein, and/or include apparatus specially constructed for the required purpose or a digital computer. Various examples also relate to apparatus or systems for performing these operations. These apparatuses may be specially constructed for the required purpose. The required structure for a variety of these machines will be apparent from the description given.

Reference is now made to the drawings, wherein like reference numerals are used to refer to like elements throughout. In the following description, for the purpose of explanation, numerous specific details are set forth in order to provide a thorough understanding thereof. It may be evident, however, that the novel examples can be practiced without these specific details. In other instances, well known structures and devices are shown in block diagram form in order to facilitate a description thereof. The intention is to cover all modifications, equivalents, and alternatives within the scope of the claims.

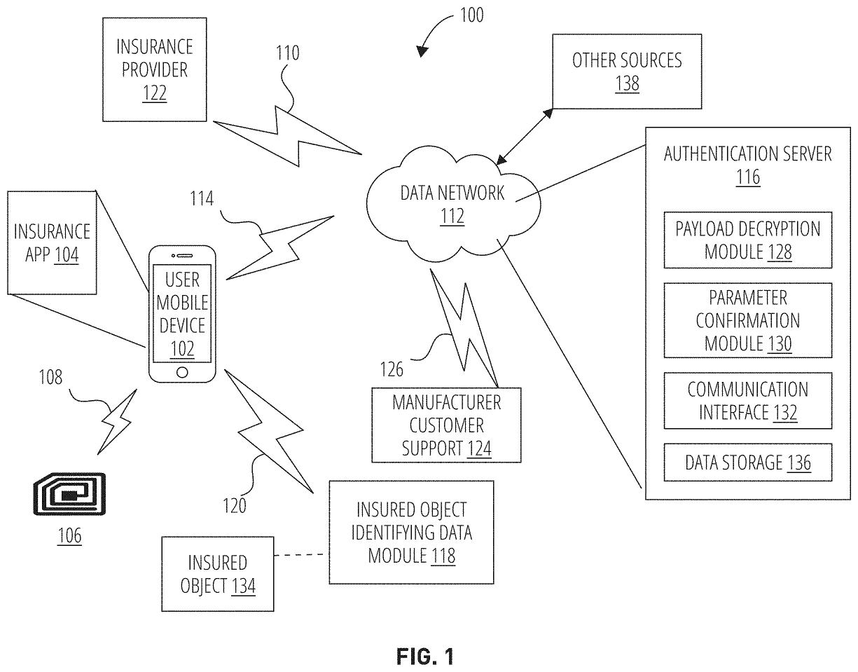

FIG. 1 illustrates a functional block diagram of a system operable to implement the disclosed subject matter.

The system 100 may be usable to ensure the legitimacy of an insurance claim request of an insured object 134. The insured object 134 may be a home, a rented apartment, computing device, vehicle (e.g., automobile, motorcycle, recreational vehicle, or watercraft) or the like that is covered by insurance. The insured object 134 may have some value that may be eligible for reimbursement or indemnification by the insurance provider 122 in response to a claim request. It is envisioned that an example system to implement a claim process that enables authentication of information related to the insured object 134. The interaction of a user mobile device 102 with the insurance provider 122 is discussed in the following example. The mobile device 102 may be a smart phone or the like as described in more detail with reference to later examples. The system 100 may be operable to implement and/or facilitate the interaction of the user mobile device 102 and the insurance provider 122 via the data network 112. The insurance provider 122 may provide insurance services via a server (as described with reference to a later example), a cloud platform or the like. The insured object 134 may include an insured object identifying data module 118 (as shown by the dashed line between the two in FIG. 1). The insured object identifying data module 118 may, for example, be a device that in its simplest from be operable to present data that identifies the insured object 134.

The data network 112 may be a cloud-based processing service, a data network, such as a cellular network, the internet, a wide area network, a local area network or the like, or a combination of networks, that facilitates the exchange of communications between the user mobile device 102, the insurance provider 122 and an authentication server 116.

In the example of an insurance claim interaction, the system 100 may include the data network 112, the insurance provider 122, a user mobile device 102 belonging to a user insured by the insurance provider 122, and the authentication server 116. The insured user may engage with the insurance provider 122 via an insurance application (app) 104 hosted on the user's mobile device 102. The user may also have a contactless card 106 having information that is authenticatable by the authentication server 116. For example, the contactless card 106 may be operable to communicate with a near-field communication device of the user mobile device 102.

As described in more detail with later examples, the information in the contactless card 106 may be usable to verify the identity of the user and also authenticate the insured object 134 as being insured by or owned by the identified user. The legitimacy of the claim request may be determined by the insurance app 104 using the verified user identity and the authenticated insured object information.

The system 100 may include an authentication server 116 provided by an entity (such as a financial institution, insurance provider, a trusted third-party vendor, or the like) that has previously verified an identify of a person and that may have provided the person with a contactless card 106 that has information usable to authenticate the identity of that person. For example, the contactless card 106, the structure of which is described in more detail below, may be operable to provide the other entities with encrypted information. The other entities, such as an insurance provider 122, may leverage the verified identity of the person by utilizing the authentication capabilities of the contactless card 106 to verify requests for services, such as in the example of the insurance provider 122, a claim for reimbursement or indemnification for a loss. Other information obtainable from Other sources 138 (e.g., police reports, public records, or the like) may also be available to the insurance provider 122. The combination of the authentication result provided by the authentication server 116 and the additional information may enable the insurance provider 122 to provide services, such as insurance claim initiation, claim verification, insured object information, and the like. The user mobile device 102 may communicate via near-field communication devices, such as a radio frequency identification (RFID) device, with the contactless card 106 to provide the encrypted information to the user mobile device 102.

In more detail, the user mobile device 102 and the insurance app 104 may receive information from other sources, such as other sources 138, as well. For example, an object that the user has insured may be operable to transmit information, for example, via a communication link 120, or may have a tag (e.g., a quick response (QR) code or bar code) from which information may be obtained. This information may be referred to as insured object identifying data that may be presented by an insured object identifying data module 118 and may include information describing the insured object, when the object was purchased, when the object was last maintained, owner information, a model number, a serial number, a vehicle identification number (VIN), warranty expiration date, or other information. The insured object identifying data module 118 may be a component of the insured object 134 that is operable to communicate wirelessly with the user mobile device 102. Alternatively, or in addition, the user mobile device 102 and insurance app 104 may receive further information about the insured object from a manufacturer of the object. The further information may be received, for example, from manufacturer customer support 124 via a network (e.g., data network 112) or by a communication device of the user mobile device 102 via the communication link 126. In instances when the insured object identifying data module 118 is unavailable or provides different information than that suggested above, the manufacturer customer support 124 may also be accessible to provide information that may include a model number, a serial number, a vehicle identification number (VIN), sales date, warranty date, or other information related to the insured object 134.

The information obtained by the insurance app 104 from the contactless card 106, the insured object identifying data module 118 and/or the manufacturer customer support 124 may be included in a claim request message. In addition to the information provided by the contactless card 106, the insured object identifying data module 118 and/or the manufacturer customer support 124, the claim request message may also include information input into the insurance app 104 that identifies a user associated with the user mobile device 102 as a person that may be reimbursed or indemnified for the claimed loss sustained to the insured object 134. In practice, the claim request message may include some or all of the information obtained by the insurance app 104, the contactless card 106, the insured object identifying data module 118 and/or the manufacturer customer support 124.

The insurance app 104 may forward the claim request message to the authentication server 116 for authentication. The authentication server 116 may include a number of software and/or hardware processing components that are operable to perform different functions that enable the authentication of the information provided by the insurance app 104. For example, the authentication server 116 may include a payload decryption module 128, a parameter confirmation module 130, a communication interface 132 and data storage 136. The communication interface 132 may be operable to communicate with the insurance app 104 of the user mobile device 102, the insurance provider 122 and/or the manufacturer customer support 124 via the data network 112.

In an operational example, the authentication server 116 may receive the claim request message from the insurance app 104 (or the insurance provider 122) for authentication. In some examples, the claim request message may only include the encrypted information obtained from the contactless card 106. In which case, the authentication server 116 may be authenticating that the encrypted information from the contactless card 106 is accurate and other processes determine the legitimacy of the claim request. As mentioned, the authentication server 116 may, in some examples, receive, in addition to the encrypted information, information related to the insured object 134. The payload decryption module 128 may be operable to decrypt the encrypted information obtained from the contactless card 106. Examples of the encryption and decryption algorithms are described in more detail with reference to later examples.

Some or all of the information from the contactless card 106 decrypted by the payload decryption module 128 may be forwarded to parameter confirmation module 130. The parameter confirmation module 130 may access the data storage 136 to retrieve data related to or matching to the decrypted information. Using the retrieved data, the parameter confirmation module 130 may be operable to determine the authenticity of the information provided by the contactless card 106. An indication of the authenticity of the information provided by the contactless card 106 may be generated by the parameter confirmation module 130 and returned to the insurance app 104 via the communication interface 132 and data network 112.

The insurance app 104 may be operable to provide any authentication confirmations to the insurance provider 122 via the data network 112 and the user mobile device 102 via communication links, such as communication link 114 and communication link 110. The communication links 110 and 114 may be data communication links such as that provided by different wireless communication modalities, such as Wi-fi®, Bluetooth®, cellular, a combination of modalities, or the like.

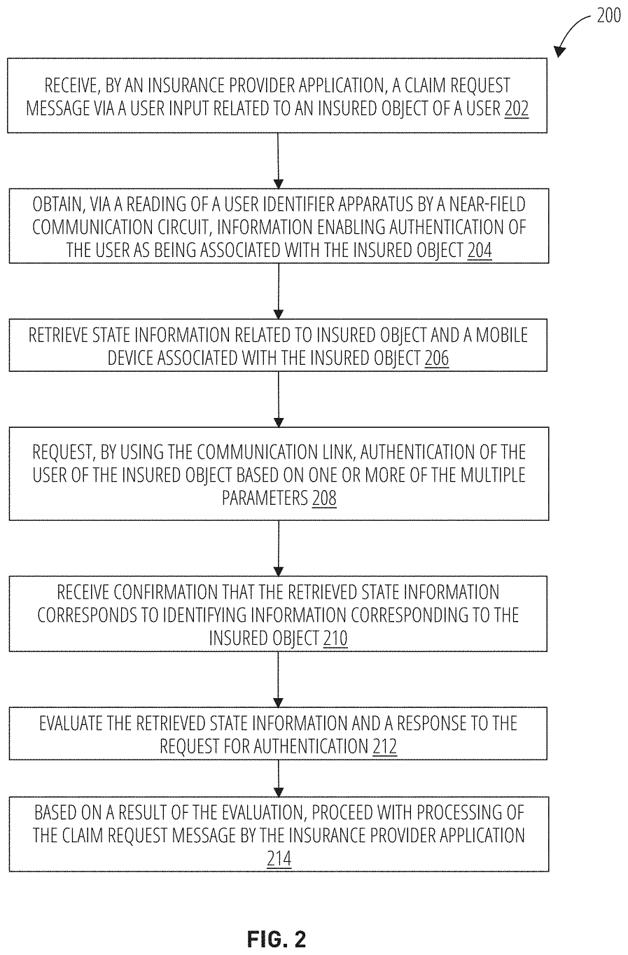

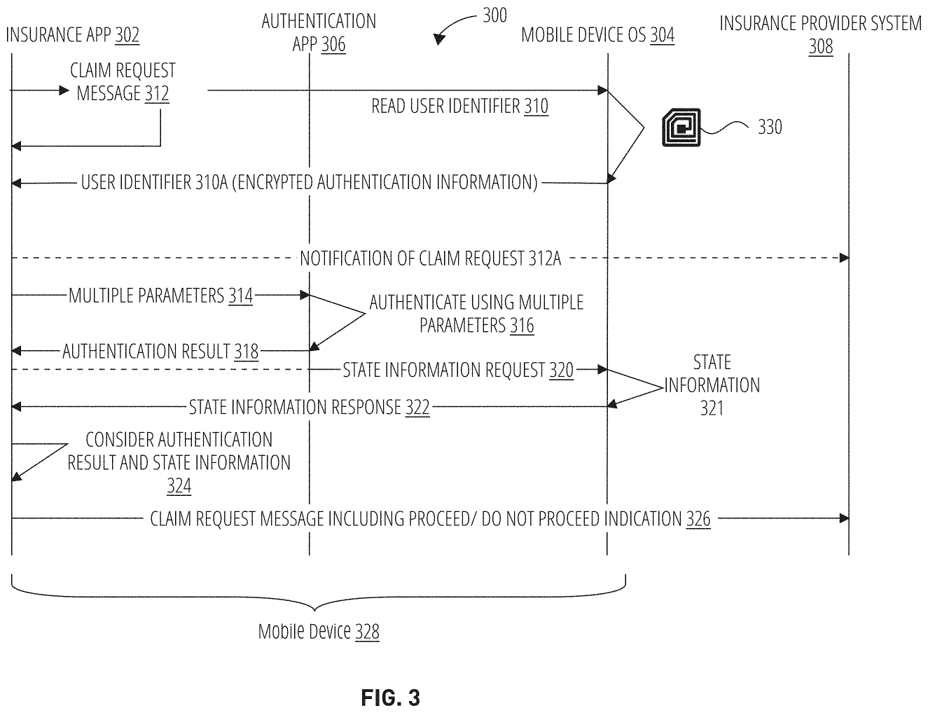

A discussion of an example exchange of information within the system 100 is provided with reference to the examples of FIG. 2 and FIG. 3.

FIG. 2 illustrates a flowchart of an example process for authenticating a request according to the disclosed subject matter. The claim request process 200 may utilize the system 100 in which the authentication server 116 is separate from the user mobile device 102 but available via the data network 112.

In block 202, a processor executing process 200 may receive, by an insurance provider application, a claim request message via a user input related to an insured object of a user.

For example, when an insured user experiences a loss, such as damage to an insured object that results from, for example, a storm, an accident, theft or the like, the insured user may open or launch the insurance app 104 to begin a claim process. For example, with reference to FIG. 1, the insurance app 104 may be operable to present a form on a display (such as a touchscreen as shown in another example) of a user mobile device 102. The presented form may be populated with information that may sufficiently identify the insured object 134 to begin the claim process. For example, the insured object 134 may be a home or automobile. Examples of identifying information that may be populated in the presented form may be an address of the home, if the home is the insured object 134 or, in the example of an automobile, the manufacturer and model.

The claim request message may be a message that includes insured object information that is related to a loss sustained by a user. Insured object information may be data that uniquely identifies an object, such as a vehicle, personal possession (e.g, jewelry or the like), that has been insured. The insured object information may be provided by components like the insured object identifying data module 118. The insured object identifying data module 118 may or may not be part of the insured object 134.

In an example, the user mobile device 102 of FIG. 1 may include a display and a near-field communication circuit both coupled to the processor, upon receipt of the claim request message from the insurance provider application, may be operable to cause presentation of a prompt on a display (shown in a later example) of the mobile device and coupled to the insurance provider application requesting that a user identifier device be read via a near-field communication circuit of a mobile device.

In block 204, the process 200 obtains, via a reading of a user identifier apparatus by a near-field communication circuit, information enabling authentication of the user as being associated with the insured object. The obtained information from the reading of the user identifier apparatus may, for example, includes a communication link (e.g., a uniform resource locator (URL), a Bluetooth address, or the like) to an authentication application (or authentication server 116 of FIG. 1) and multiple parameters. The multiple parameters may include a version number related to the user identifier device, a unique identifier of the user, an application transaction counter, a one-time password, or a cryptogram usable to validate the integrity and legitimacy of the claim request.

For example, the user identifier apparatus, also referred to as a credential apparatus, may be a contactless card 106 as shown in FIG. 1. The authentication server 116 may be operable to decrypt and evaluate the information provided in the payload of the contactless card 106.

In block 206, the process 200 may be operable to retrieve the state information related to insured object and a mobile device associated with the insured object. In an example, the state information includes global positioning satellite (GPS) location information, information related to a wireless communication link between the insured object and the mobile device, and status of safety or security equipment. In addition, or alternatively, the user mobile device 102 may, for example, be operable to obtain location information of the mobile device. The insurance app 104 may use the state information, for example, to confirm that the obtained location information of the mobile device corresponds to a location of the insured object using one or more of: a location of the insured object set in the insurance provider application, a mapping application, or a publicly-available sales record.

In an example, the user mobile device 102 may be operable to connect with the data network 112 via, for example, a cellular transceiver, a data network transceiver or the like within the user mobile device 102. Using the connection with the data network 112, the insurance app 104 may be operable, during the execution of process 200 at block 208, to send a request, by using the communication link, for authentication of the user of the insured object. The sent request may include one or more of the multiple parameters.

In addition, or alternatively, in a more detailed example, the authentication server 116 may be operable to obtain from the claim request message an internet protocol address associated with the insured object. In this example, the insured object is a residence. The authentication server may review an interaction history of the user with the insurance provider application to locate the internet protocol address in the insured object information as confirmation that the claim request is legitimate. The results of the reviewing of the interaction history may be analyzed to determine whether the internet protocol address is an internet protocol address most frequently associated with user interactions by the user with the insurance provider application. In response to the analysis, the authentication server 116 may provide an indication that the internet protocol address is the internet protocol address most frequently associated with the user interactions by the user with insurance provider application.

The process 200, at block 210, may receive confirmation that the retrieved state information corresponds to identifying information corresponding to the insured object. Using this information, the insurance app 104 may be able to perform an evaluation of whether the claim request is legitimate based on an authentication of the user information provided by multiple parameters obtained from the contactless card 106.

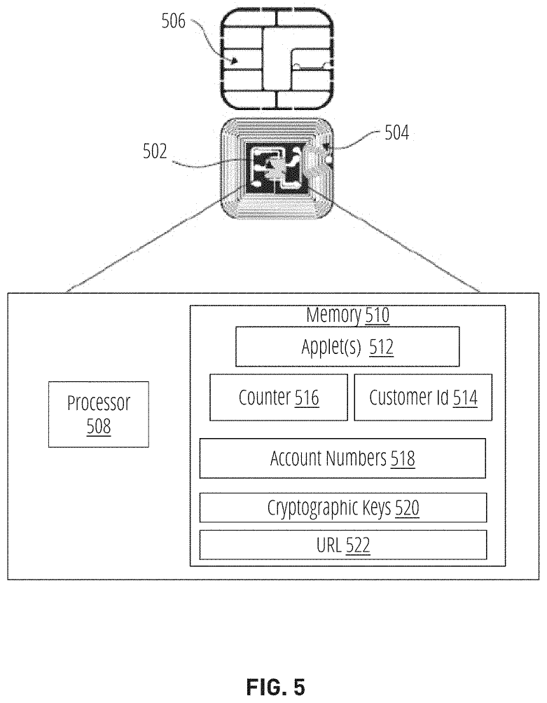

In block 212, the process 200 as executed by the insurance app 104 may evaluate the retrieved state information and a response to the request for authentication received from the authentication server 116. In making the evaluation, the insurance app 104 may consider an indication provided by the authentication server 116 that the multiple parameters are valid. In addition, the insurance app 104 may consider indications that the information about the insured object 134 and the information provided in the claim request (e.g., mailing address, telephone numbers, email addresses, banking or credit account information, or the like) is legitimate and therefore, may be authenticated. The authentication process of the information provided by the contactless card 106 may, for example, utilize the key diversification and the information obtainable therefrom as described with reference to FIG. 5.

In block 214, based on a result of the evaluation, the process 200 proceeds with processing of the claim request message by the insurance provider application. When the result of the evaluation indicates that the claim request is legitimate, the insurance app 104 may generate an indication that the claim has been accepted and, for example, will be further handled according to the claim processing procedures of the insurance provider 122. Conversely, when the result of the evaluation indicates that the claim request is suspect, the insurance app 104 may generate an indication that additional information is required and that the user ought to call customer service of the insurance provider 122.

FIG. 3 illustrates a communication flow diagram in accordance with an example of the disclosed subject matter. In contrast to the example of FIG. 2, the example of FIG. 3 is directed to a process in which initiation of the claim process and an authentication of a claim request may occur within the mobile device. Other use cases and examples are also envisioned.

In the communication flow example, a system may include a mobile device 328 and an insurance provider system 308. The mobile device 328 may be a computing device including a processor and memory as explained with reference to later figures and examples and may include an insurance application (app) 202, a mobile device operating system (OS) 304, and an authentication application (app) 306. The insurance app 202, the authentication app 306 and the mobile device OS 304 may operate a processor of the mobile device 328. The insurance app 302 may be provided by the insurance provider system 308. The insurance app 302 and the authentication app 306 may be stored in a memory (shown in a later example) of the mobile device 328.

As discussed above, when an insured user experiences a loss, such as damage to an insured object that results from, for example, a storm, an accident, theft or the like, the insured user may open or launch the insurance app 302 to begin a claim process. For example, the insurance app 302 may be operable to present a form on a display (such as a touchscreen as shown in another example) of the mobile device 328. The presented form may be populated with information that may sufficiently identify the insured object 134 to begin the claim process. For example, the insured object 134 may be a home or automobile. Examples of identifying information that may be populated in the presented form may be an address of the home, if the home is the insured object 134 or, in the example of an automobile, the manufacturer and model.

In an operational example encompassing the communication flow of claim request process 300 of FIG. 3, the insurance app 302 may receive inputs from a user that enables the insurance app 302 to generate a claim request message 312. The claim request message 312 includes information related to a loss sustained by a user. For example, the claim request message 312 may include information about an insured object (not shown in this example) that may be used when initiating a claim request as discussed earlier.

The insurance app 302 may forward instructions to the mobile device OS 304 that cause a processor (described in a later example) of the mobile device 328 to generate a prompt on a display device of the mobile device 328 requesting that the user brings a credential apparatus 330 within near-field communication range of the 328. The read user identifier 310 may be an instruction for the mobile device 328 to read information from the credential apparatus 330 (also referred to as a user identifier apparatus) that may be used to identify the user or confirm the user of the mobile device 328 is who they assert that they are.

In the example, the credential apparatus 330 may be external to the mobile device 328 and provides information that enables authentication of the claim request to the insurance provider system 308. The credential apparatus 330 may be a credit card, debit card, an identification card, a key fob, a pendant, a bracelet, a smart, wearable device or the like. The credential apparatus 330 may maintain encrypted authentication information that is usable to authenticate an identity of a user. The encrypted authentication information may include a reference link and/or multiple parameters. The multiple parameters may, for example, include a version number (related to the credential apparatus 330), a unique identifier of the user, an application transaction counter, a one-time password, a cryptogram or the like that may be usable to authenticate the claim request. The version number may be indicative of a time period during which the credential apparatus 330 was issued, a type of encryption algorithm, issue date or the like. The unique identifier of the user may be an alphanumeric identifier associated with the user that may, for example, be based on a hash function, a government or enterprise issued identification numbers, an identifier associated with the mobile device 328, and the like. The application transaction counter, the one-time password and the cryptogram are explained with reference to later examples. In addition, the credential apparatus 330 have, or may be, a near-field communication device that is operable to provide encrypted authentication information to a near-field communication device (not shown in this example) of the mobile device 328. In addition to the parameters obtained from the user identifier apparatus of a version number related to the user identifier apparatus, a unique identifier of the user, an application transaction counter, a one-time password maintained by the user identifier apparatus, or a cryptogram, the multiple parameters may also include information related to the mobile device 328, such as an International Mobile Equipment Identity (IMEI) number, a user password to access the mobile device, biometric information of the user obtained, for example, by sensors (not shown) of the mobile device, or serial number of the mobile device 328. All or some of the multiple parameters may be usable to validate the claim request as legitimate.

Returning to the example, in response to the credential apparatus 330 being successfully read by a near-field communication device of the mobile device 328, the mobile device OS 304 may return the user identifier 310A (i.e., encrypted authentication information maintained on credential apparatus 330) to the insurance app 302. In the example, the insurance app 302 may keep a copy of the claim request message 312 that may be combined with the user identifier 310A received from the mobile device OS 304.

The notification of claim request 312A provides the insurance provider system 308 with at least some indication that a claim request is forthcoming or that a potentially fraudulent claim request was attempted.

Upon receipt of the user identifier 310A, the insurance app 302 may be operable to, optionally, cause the mobile device 328 processor to send a notification of claim request 312A, which may be a preliminary notification of a potential claim request, to the insurance provider system 308. For example, in response to the notification of claim request 312A, the insurance provider system 308 may proceed with or initiate preliminary claim processing steps.

The mobile device 328 may also host an authentication app 306. The authentication app 306 may be executed by the processor of the mobile device 328 in cooperation with a secure element. For example, a secure element may be maintained by the mobile device 328. The secure element may, for example, be an integrated chip that may include a secure memory and a secure processor that is protected from unauthorized access and used to run a limited set of applications, as well as store confidential and cryptographic data. The secure element can store and process information such as personal identification number (PIN) codes, passwords, fingerprints, payment information, the multiple parameters, and much more.

Continuing with the operational example, the authentication app 306 may be operable to receive the multiple parameters 314 from the insurance app 302. For example, the insurance app 302 may utilize the reference link to access the authentication app 306, in which case, the multiple parameters, which are encrypted, are forwarded to the authentication app 306 for decryption and processing. Alternatively, the authentication app 306 may be operable to forward the encrypted authentication information including the multiple parameters and the reference link obtained with the user identifier 310A to the authentication app 306 for processing as the multiple parameters 314. In this example, the reference link may be usable by the authentication app 306 to be directed to the insurance provider system 308 or an authentication server, such as 116 of FIG. 1.

The authentication app 306 may authenticate using multiple parameters 316. For example, the authentication app 306 may attempt to decrypt the encrypted multiple parameters using a private cryptographic key associated with the credential apparatus 330. Once decrypted, the authentication app 306 may use the multiple parameters 314 authenticate to whether the claim request is being submitted by a verified user associated with the mobile device 328. Additional information may cross verify the user with the insurance app 302 (e.g., the insurance app 302 may have information that uniquely identifies the user that corresponds to some or all of the multiple parameters 314 or reference link obtained in the user identifier 310A).

For example, the authentication app 306 may be operable in combination with the secure element to decrypt part or all of the encrypted authentication information. The authentication app 306 may be further operable to compare the decrypted authentication information to unique identifying information stored in or generated within the secure element.

By authenticating using multiple parameters 314, the authentication app 306 may return an authentication result 318 to the insurance app 302.

In addition, the authentication app 306 or the insurance app 302 may request state information of an insured item that is the subject of the claim request message 312. For example, either the insurance app 302 (as represented by the dashed line) or the authentication app 306 may make a state information request 320, which is a request for information related to the state of the insured object. The mobile device OS 304 may be operable, in response to the state information request 320, to obtain state information 321 related to the insured object.

For example, the insurance app 302 may be operable to forward an application programming interface call to the mobile device OS 304 (i.e., the operating system of the mobile device 328). In response, the insurance app 302 receive communication link information related to a communication link between the mobile device and the insured object (e.g., a reference link, a Bluetooth address of the insured object, a wireless communication (such as Bluetooth) pairing code, or the like). The communication link information may be maintained as part of the state information.

The state information may be obtained from a machine readable code (such as a barcode, QR code or the like) on the insured object, from a communication device, whether an RFID tag, a near-field communication (NFC) device, a wireless communication transceiver (e.g., Bluetooth device), or the like. For example, the state information 321 may include GPS location information, information obtained via a wireless communication link (e.g., Bluetooth or the like) between the insured object and the mobile device, and the like. The details of the wireless communication link, such as insured object name, secure passwords usable in a handshaking protocol, information such as a Bluetooth identifier of a Bluetooth-enabled communication device within the insured object and/or a Bluetooth identifier of a Bluetooth-enabled communication device within the mobile device, or a uniform resource locator (URL) may be provided as a parameter included in the information provided with the user identifier 310A. In a further example, the insurance app 302 may cause the mobile device 328 to obtain from the automobile via a Bluetooth connection a media access control (MAC) address used by the automobile. The provided MAC address, which may be included as state information 321, may be used to identify the make and model of the automobile and/or to confirm that the mobile device 328 has previously paired with the automobile. The MAC address may, for example, serve as a wireless communication link identifier between the insured object and the mobile device. This provides additional collaborating evidence of the relationship between the insured object and the user making the claim.

Alternatively, insurance app 302 may be operable to communicate via another wireless connection of the mobile device 328, such as a cellular data connection or Wi-fi connection, in which the URL of the parameters may be used to navigate a data network, such as the internet, and/or data providers to obtain state information related to the insured object. For example, the home address input into the claim request form may be used to object state information using one or more of the communication systems (shown in a later example) of the mobile device 328.

For example, newer model automobiles have computers coupled to Bluetooth transceivers that communicate with a driver's mobile device. The driver may be the insured user and the automobile may be the insured object. The automobile computers monitor the state of a number of systems within the automobile, such as a status of safety equipment (e.g., airbag deployment information, automated brake system, and the like) or the automobile security equipment. In the example of a home being the insured items, home automation systems monitor not only operational systems of a home (e.g., air conditioning, hot water, door locks and the like), but also security system elements, and may be operable to indicate smoke alarm activation status, security system operational status and the like. The state of the systems may be provided as state information 321. The provided state information 321 may be used to derive additional information regarding the insured object, the mobile device and/or the insured user.

The mobile device OS 304 may return a state information response 322 that includes the state of the insured object. The 302 may consider authentication result and state information 324. For example, the state information of the insured object in the state information response 322 may align with data accessible by the insurance app 302. For example, the state information may be maintained in the secure element or a memory of the mobile device 328. Alternatively, while not shown in the example, the insurance app 302 may request information from the insurance provider system 308. For example, in response to the notification of claim request 312A, the insurance provider system 308 may download information related to the insured object included in the claim request message 312.

When consider authentication result and state information 324, the insurance app 302 may also evaluate the authentication result 318 as to whether the user is an authenticated user and/or that the information provided with the user identifier 310A in response to the claim request has been authenticated. Based on a result of the consideration, the insurance app 302 may generate a claim request message including proceed/do not proceed indication 326.

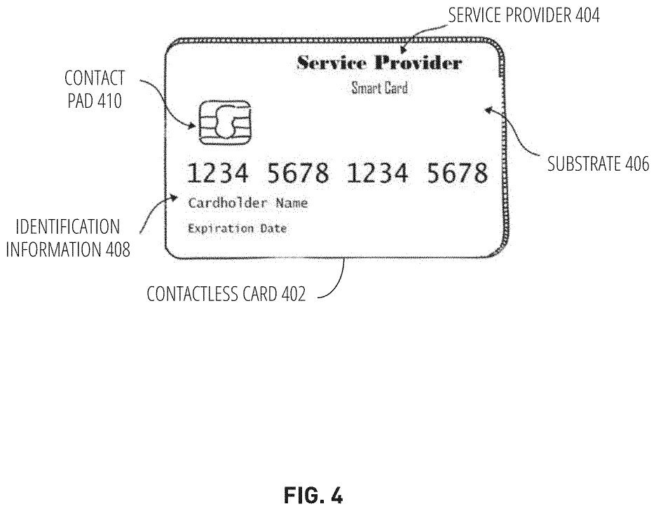

The system comprises a contactless card 402, a service provider 404, a substrate 406, an identification information 408, and a contact pad 410. FIG. 4 illustrates a contactless card 402, which may comprise a payment card, such as a credit card, debit card, and/or an identification card that may act as a credential apparatus. Other examples of an authentication apparatus may be a key fob, a pendant, a bracelet, a smart wearable device (e.g., a fitness device or a smartwatch) or the like. As shown, the contactless card 402 may be issued by a service provider 404 displayed on the front or the back (not shown) of the contactless card 402. In some examples, the contactless card 402 is not related to a payment card, and may comprise, without limitation, an identification card or an insurance card. In some examples, the contactless card 402 may be a dual interface contactless payment card. For example, the contactless card 402 may include a substrate 406, which may have a single layer, or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 402 may have physical characteristics compliant with the ID-1 format of the ISO/IEC 7610 standard, and the contactless card 402 may otherwise be compliant with the ISO/IEC 14443 standard. However, it is understood that the contactless card 402 according to the present disclosure may have different characteristics, and the present disclosure does not require a contactless card to be implemented in a payment card.

The contactless card 402 may also include identification information 408 displayed on the front and/or back of the card, and a contact pad 410. The contact pad 410 may be configured to establish contact with another communication device, such as the mobile device 102 via communication link 108 of FIG. 1, a smart device, laptop, desktop, or tablet computer. The contactless card 402 may also include processing circuitry, antenna and other components not shown in FIG. 4. These components may be located behind the contact pad 410 or elsewhere on the substrate 406. The contactless card 402 may also include a magnetic strip or tape, which may be located on the back of the card (not shown in FIG. 4).

As illustrated in FIG. 5, an example of a contact pad 506 useable with the contactless card 402 may include processing circuitry 502 for storing and processing information, including a microprocessor 508 and the memory 510. It is understood that the processing circuitry 502 may contain additional components, including processors, memories, error and parity/CRC checkers, data encoders, anti-collision algorithms, controllers, command decoders, security primitives and tamper-proofing hardware, that may be operable to perform the functions described herein.

For example, the memory 510 may be a read-only memory, write-once read-multiple memory or read/write memory, e.g., RAM, ROM, and EEPROM, and the contactless card 402 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. A read/write memory may also be read many times after leaving the factory.

The memory 510 may be configured to store one or more applet(s) 512, one or more counters 516, a customer identifier (Id) 514, and the virtual account numbers 518. The one or more applets 440 may comprise one or more software applications configured to execute on one or more contactless cards, such as a Java® Card applet. However, it is understood that applet(s) 512 are not limited to Java Card applets, and instead may be any software application operable on contactless cards or other devices having limited memory. The one or more counters 516 may comprise a numeric counter sufficient to store an integer. The customer id 514 may comprise a unique alphanumeric identifier assigned to a user of the contactless card 402, and the customer id 514 may distinguish the user of the contactless card from other contactless card users. In some examples, the customer identifier 514 may identify both a customer and an account assigned to that customer and may further identify the contactless card associated with the customer's account. As stated, the account numbers 518 may include thousands of one-time use virtual account numbers associated with the contactless card 402. An applet 512 of the contactless card 402 may be configured to manage the account numbers 518.

The processor and memory elements of the foregoing exemplary examples are described with reference to the contact pad, but the present disclosure is not limited thereto. It is understood that these elements may be implemented outside of the contact pad 506 or entirely separate from it, or as further elements in addition to microprocessor 508 and memory 510 elements located within the contact pad 506.

In some examples, the contactless card 402 may comprise one or more antennas 504. The one or more antennas 504 may be placed within the contactless card 402 and around the processing circuitry 502 of the contact pad 506. For example, the one or more antennas 504 may be integral with the processing circuitry 502 and the one or more antennas 504 may be used with an external booster coil. As another example, the one or more antennas 504 may be external to the contact pad 420 and the processing circuitry 502. More generally, using the antennas 504, processing circuitry 502, and/or the memory 510, the contactless card 402 provides a communications interface to communicate via NFC, Bluetooth, and/or Wi-Fi communications as described with reference to the examples of FIGS. 1-3.

As explained above, contactless cards 402 may be built on a software platform operable on smart cards or other devices having limited memory, such as JavaCard, and one or more or more applications or applets may be securely executed. Applet(s) 512 may be configured to respond to one or more requests, such as near field data exchange (NDEF) requests, from a reader, such as a mobile NFC reader (e.g., of the mobile device 102 or 328), and produce, for example, an NDEF message that comprises a cryptographically secure encrypted information encoded as an NDEF text tag.

In some examples, the contactless card 402 and/or mobile device (e.g., 102 or 328) may include certain data such that the card and the user may be properly identified and authenticating information obtained for processing. The contactless card 402 may comprise one or more unique identifiers (not shown). Each time a read operation takes place, the counters 516 may be configured to increment. In some examples, each time data from the contactless card 402 is read (e.g., by a mobile device 102 or 328), the counter 516 as one of the multiple parameters may be used by the authentication server 116, authentication app 306 or authentication app 704 to authenticate other parameters of the multiple parameters. For example, the counter 516 value may be compared to a trusted counter value (e.g., maintained in a secure element or by an authentication server 116) determined to be equal and therefore, the other parameters may be considered authentic.

The one or more counters 516 may be configured to prevent a replay attack. For example, if a cryptogram has been obtained and replayed, that cryptogram is immediately rejected if the counter 516 has been read, used or otherwise passed over. If the counter 516 has not been used, it may be replayed. In some examples, the counter that is incremented on the card is different from the counter that is incremented for transactions. The contactless card 402 is unable to determine the application transaction counter 516 since there is no communication between applet(s) 512 on the contactless card 402. In some examples, the contactless card 402 may include multiple applets 512, such as a first applet, which may be a transaction applet, and a second applet that monitors a number of times or when the counter 516 is read.

The encrypted information delivered to the mobile device, such as user mobile device 102 or mobile device 328 may include a reference link, such as URL 522. The URL 522 may provide to an authentication application once the user taps the contactless card 402 to the mobile device. For example, in response to contactless card 402 being engaged to communicate with a mobile device, whether it is user mobile device 102 or mobile device 328, the contactless card 402 may be operable to generate encrypted information. However, as shown, the memory 510 of the contactless card 402 includes a uniform resource locator (URL) 522. The URL 522 may be stored in the memory 510 and/or may be generated by the applet 512. The URL 522 may be directed to the authentication server 116, the authentication app 306 or the insurance provider 122 of FIG. 1. The URL 522 may further include data (e.g., parameters) used by the authentication server 116 to validate the data generated by the contactless card 402. For example, the applet 512 of the contactless card 402 may include the multiple parameters of the encrypted information as a parameter of the URL. The authentication app 306 or the authentication server 116 may attempt to decrypt the encrypted information using a private key associated with the contactless card 402 of the primary account.

For example, the encrypted information may be a string of characters, for example, “ABC123”. The applet(s) 512 may include the generated encrypted information as a parameter of the URL 522, thereby generating a URL with encrypted information. For example, the URL 522 to the authentication server 116 may be “http://www.example.com/”. Therefore, the URL 522 with encrypted information may be “http://www.example.com/? ABC123”. In some embodiments, the applet(s) 512 may encode the encrypted information according to an encoding format compatible with URLs prior to including the encrypted information as a parameter of the URL 522. For example, the encrypted information may be a string of binary data (e.g., zeroes and ones), which may not be compatible with URLs. Therefore, the applet 103 may encode the encrypted information to the American Standard Code for Information Interchange (ASCII) base64 encoding format. Doing so represents the binary encrypted information in an ASCII string format by translating it into a radix-64 representation (e.g., “ABC123” in the previous example).

Once generated, the applet(s) 512 may transmit the URL 522 with encrypted information to the user mobile device 102 or mobile device 328, e.g., via NFC. In one embodiment, when received by the user mobile device 102 or a mobile device 328, an application, such as the insurance app 104 may open to access the URL 522 with encrypted information and transmit the encrypted to an authentication server, such as 116, addressed by the URL 522.

A key diversification technique described herein with reference to the counter 516 that may include cryptographic keys 520 (e.g., a master key and a diversified key) is one example of a key diversification technique. This example key diversification technique should not be considered limiting of the disclosure, as the disclosure is equally applicable to other types of key diversification techniques.

For example, during the creation process of the contactless card 402, the two cryptographic keys may be assigned uniquely per card. The cryptographic keys 520 may comprise symmetric keys which may be used in both encryption and decryption of data. In an example, triple data encryption algorithm (3DES) may be used by a payment method such as Europay, Mastercard and Visa (EMV) and it is implemented by hardware in the contactless card 402. By using the key diversification process, one or more keys may be derived from a master key based upon uniquely identifiable information for each entity that requires a cryptographic key.

In some examples, to overcome deficiencies of 3DES algorithms, which may be susceptible to vulnerabilities, a session key may be derived (such as a unique key per session) but rather than using the master key, the unique card-derived keys and the counter may be used as diversification data. For example, each time the contactless card 402 is used in operation, a different key may be used for creating a tag, such a message authentication code (MAC), and for performing the encryption. This results in a triple layer of cryptography. The session keys may be generated by the one or more applets and derived by using the application transaction counter with one or more algorithms (as defined in EMV 4.3 Book 2 A1.3.1 Common Session Key Derivation).

Further, the increment for each card may be unique, and assigned either by personalization, or algorithmically assigned by some identifying information. For example, odd numbered cards may increment by 2 and even numbered cards may increment by 5. In some examples, the increment may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In another example, the NDEF record may be encoded in hexadecimal format.

In some examples, the present disclosure refers to a tap of the contactless card. However, it is understood that the present disclosure is not limited to a tap, and that the present disclosure includes other gestures (e.g., a wave or other movement of the card).

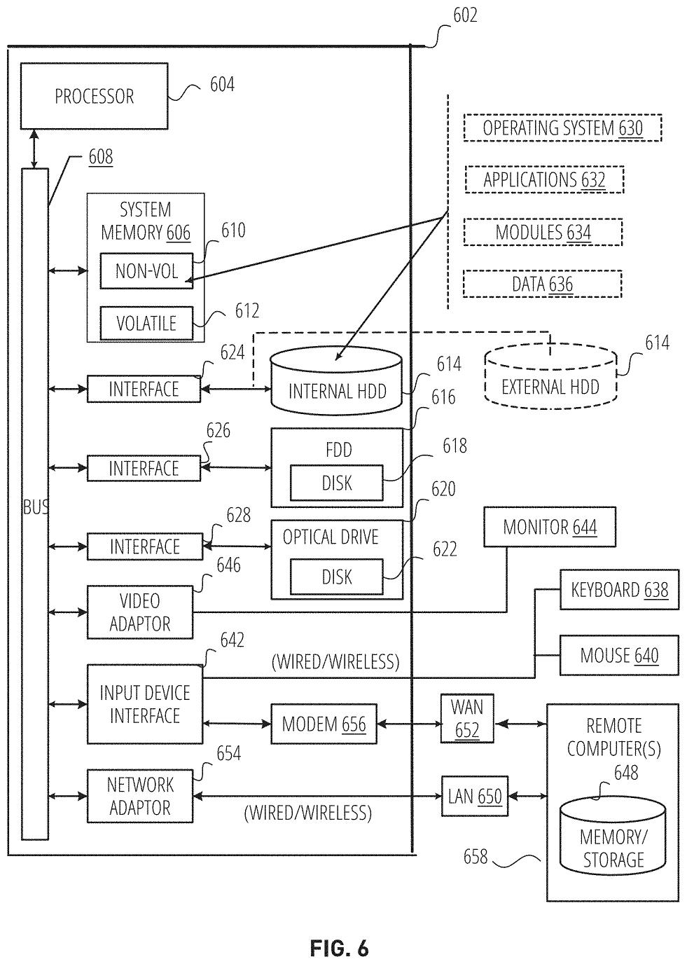

FIG. 6 illustrates an example of an exemplary computing architecture 602 that may be suitable for implementing various examples as previously described. In various examples, the computing architecture 602 may comprise or be implemented as part of an electronic device. In some examples, computing architecture 602 may be representative, for example, of the user mobile device 102, insurance provider 122 and authentication server 116 of the system 100. The examples are not limited in this context. More generally, the computing architecture 602 may be operable to implement all logic, applications, systems, methods, apparatuses, and functionality described herein with reference to FIGS. 1-5.

As used in this application, the terms “system” and “component” and “module” are intended to refer to a computer-related entity, either hardware, a combination of hardware and software, software, or software in execution, examples of which are provided by the exemplary computing architecture 800. For example, a component can be, but is not limited to being, a process running on a computer processor, a computer processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further examples, however, may alternatively employ data messages. Such data messages may be sent across various connections. Exemplary connections include parallel interfaces, serial interfaces, and bus interfaces.

The computing architecture 602 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The examples, however, are not limited to implementation by the computing architecture 602.

As shown in FIG. 6, the computing architecture 602 comprises a processor 604, a system memory 606 and a system bus 608. The processor 604 can be any of various commercially available computer processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core®, Core (2) Duo®, Itanium®, Pentium®, Xeon®, and XScale® processors; and similar processors. Dual microprocessors, multi-core processors, and other multi-processor architectures may also be employed as the processor 604.

The system bus 608 provides an interface for system components including, but not limited to, the system memory 606 to the processor 604. The system bus 608 can be any of several types of bus structure that may further interconnect to a memory bus (with or without a memory controller), a peripheral bus, and a local bus using any of a variety of commercially available bus architectures. Interface adapters may connect to the system bus 608 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (PCI), PCI Extended (PCI(X)), PCI Express, Personal Computer Memory Card International Association (PCMCIA), and the like.

The system memory 606 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory (e.g., one or more flash arrays), polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated example shown in FIG. 6, the system memory 606 can include non-volatile memory 610 and/or volatile memory 612. A basic input/output system (BIOS) can be stored in the non-volatile memory 610.

The computing architecture 602 may include various types of computer-readable storage media in the form of one or more lower speed memory units, including an internal (or external) hard disk drive (HDD) 614, a magnetic floppy disk drive (FDD) 616 to read from or write to a removable magnetic disk 618, and an optical disk drive 620 to read from or write to a removable optical disk 622 (e.g., a CD-ROM or DVD). The HDD 614, FDD 616 and optical disk drive 620 can be connected to the system bus 608 by an HDD interface 624, an FDD interface 626 and an optical drive interface 628, respectively. The HDD interface 624 for external drive implementations can include at least one or both of Universal Serial Bus (USB) and IEEE 1394 interface technologies. The computing architecture 602 is generally is configured to implement all logic, systems, methods, apparatuses, and functionality described herein with reference to FIGS. 1-5.

The drives and associated computer-readable media provide volatile and/or nonvolatile storage of data, data structures, computer-executable instructions, and so forth. For example, a number of program modules can be stored in the drives and memory units 610, 612, including an operating system 630, one or more application programs (also referred to only as applications) 632, other program modules 634, and program data 636. In one example, the one or more application programs 632, other program modules 634, and program data 636 can include, for example, the various applications and/or components of the system 100, e.g., the payload decryption module 128, parameter confirmation module 130, insurance app 104, and insured object identifying data module 118.

A user, for example, can enter commands and information into the computing architecture 602 through one or more wire/wireless input devices, for example, a keyboard 638 and a pointing device, such as a mouse 640. Other input devices may include microphones, infra-red (IR) remote controls, radio-frequency (RF) remote controls, game pads, stylus pens, card readers, dongles, fingerprint readers, gloves, graphics tablets, joysticks, keyboards, retina readers, touch screens (e.g., capacitive, resistive, etc.), trackballs, trackpads, sensors, styluses, and the like. These and other input devices are often connected to the processor 604 through an input device interface 642 that is coupled to the system bus 608 but can be connected by other interfaces such as a parallel port, IEEE 1394 serial port, a game port, a USB port, an IR interface, and so forth.

A monitor 644 or other type of display device is also connected to the system bus 608 via an interface, such as a video adaptor 646. The monitor 644 may be internal or external to the computing architecture 602. In addition to the monitor 644, a computer typically includes other peripheral output devices, such as speakers, printers, and so forth.

The computing architecture 602 may operate in a networked environment using logical connections via wire and/or wireless communications to one or more remote computers, such as a remote computer 658. The remote computer 658 can be a workstation, a server computer, a router, a personal computer, portable computer, microprocessor-based entertainment appliance, a peer device or other common network node, and typically includes many or all of the elements described relative to the computing architecture 602, although, for purposes of brevity, only a memory/storage device 648 is illustrated. The logical connections depicted include wire/wireless connectivity to a local area network (LAN) 650 and/or larger networks, for example, a wide area network (WAN) 652. Such LAN and WAN networking environments are commonplace in offices and companies, and facilitate enterprise-wide computer networks, such as intranets, all of which may connect to a global communications network, for example, the Internet. In examples, the data network 112 of FIG. 1 may be one or more of the LAN 650 and the WAN 652.

When used in a LAN networking environment, the computing architecture 602 is connected to the LAN 650 through a wire and/or wireless communication network interface or network adaptor 654. The network adaptor 654 can facilitate wire and/or wireless communications to the LAN 650, which may also include a wireless access point disposed thereon for communicating with the wireless functionality of the network adaptor 654.

When used in a WAN networking environment, the computing architecture 602 can include a modem 656, or is connected to a communications server on the WAN 652 or has other means for establishing communications over the WAN 652, such as by way of the Internet. The modem 656, which can be internal or external and a wire and/or wireless device, connects to the system bus 608 via the input device interface 642. In a networked environment, program modules depicted relative to the computing architecture 602, or portions thereof, can be stored in the remote memory/storage device 648. It will be appreciated that the network connections shown are exemplary and other means of establishing a communications link between the computers can be used.

The computing architecture 602 is operable to communicate with wired and wireless devices or entities using the IEEE 802 family of standards, such as wireless devices operatively disposed in wireless communication (e.g., IEEE 802.16 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

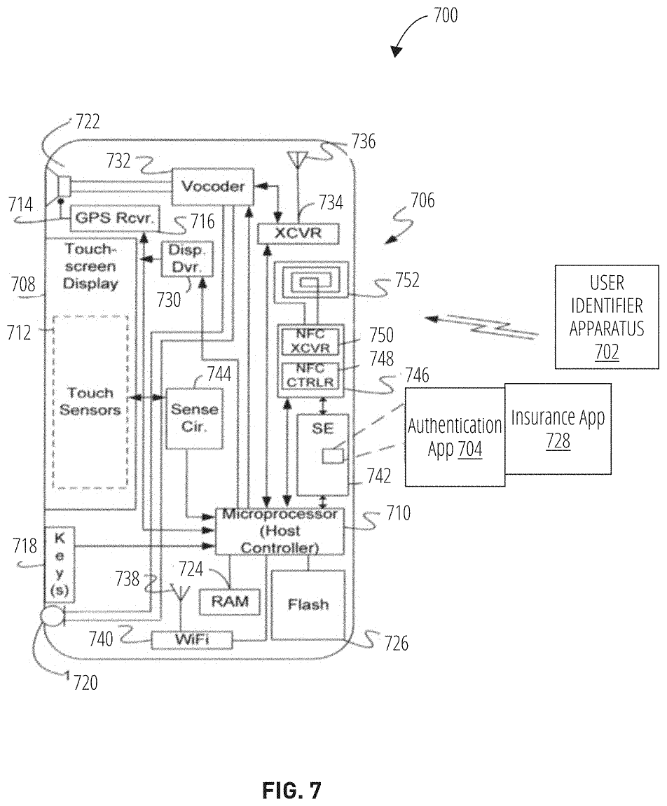

FIG. 7 illustrates an example of a system including a mobile device usable for implementing the techniques and processes discussed with reference to the examples of FIGS. 1-5. The illustrated system 700 may include a 706 and a user identifier apparatus 702.

The mobile device 706 may be a smart phone including a display device, such as a touch screen display 708. The touch screen display 708 may be coupled to the processor 710 and be operable to present screen content and receive inputs via touch sensors 712. The inputs to the touch sensors 712 may be processed by the sense circuitry 744. Examples of touch screen type mobile devices, such as mobile device 706, may include (but are not limited to) a smart phone, personal digital assistant (PDA), tablet computer, smart watch, or another portable device. However, the structure and operation of mobile device 706 that utilizes a touch screen is provided by way of example; and the subject technology as described herein is not intended to be limited thereto.

There are a variety of ways that a mobile device 706 may be operable to obtain information as to current location of the device. In our example, the mobile device 706 includes a global positioning satellite (GPS) receiver 716 and associated antenna 714. GPS is a space-based satellite navigation system that provides location and time information practically anywhere on Earth. The GPS receiver 716 may be used to provide the GPS location information. A rechargeable battery (not shown) may provide electrical power sufficient to power the various components of the mobile device 706.

The mobile device 706 further includes a processor 710, which serves as a programmable controller for mobile device 706 by configuring mobile device 706 to perform various operations, for example, in accordance with instructions or programming executable by processor 710. For example, such operations may include various general operations of the mobile device 706 as well as operations related to the screen brightness adjustment as described herein. A flash memory 726 may be used to store, for example, programming or instructions for execution by the processor 710. Depending on the type of device, the mobile device 706 stores and runs an operating system through which specific applications may be run on the device. Examples of operating systems include Android, Apple iOS, Microsoft Windows OS, Bada, Tizen, Symbian OS, Blackberry OS, or the like. Flash memory 726 may also be used to store mobile configuration settings for different mobile applications or services executable at mobile device 706 (using processor 710). Mobile device 706 may also include a non-volatile random-access memory (RAM) 724 for a working data processing memory. The RAM memory 724, flash memory 726, and secure element storage 742 may be coupled to the processor 710 and operable to store programming code executable by the processor 710.

A mobile device supporting the claim processing and authentication techniques described herein may include a variety of different types of user interface elements. For discussion purposes, in the smart phone example of a mobile device shown in FIG. 7, the user interface elements of mobile device 706 include the touch screen display 708. For output purposes, the touch screen display 708 may include a display screen, such as a liquid crystal display (LCD) or the like. For input purposes, touch screen display 708 includes a plurality of touch sensors 712 that output signals processed by sense circuitry 744. Other interface elements may include a keypad including one or more keys 718. For example, the keypad may be implemented in hardware as a T9 or QWERTY keyboard of mobile device 706 and keys 718 may correspond to the physical keys of such a keyboard. Alternatively, keys 718 (and keyboard) of mobile device 706 may be implemented as “soft keys” of a virtual keyboard graphically represented in an appropriate arrangement via touch screen display 708. The soft keys presented on the touch screen display 708 may allow the user of mobile device 706 to invoke the same user interface functions as with the physical hardware keys. In some implementations, the microphone 720 and speaker 722 may be used as additional user interface elements, for audio input and output, including with respect to some functions related to the processing related to engaging with the authentication app 704, as described herein. In a further example, the authentication app 704 may in response to accessing contacts stored in the RAM memory 724, present in the user interface a prompt to a user to enter information regarding an insurance claim for execution by the insurance app 728.

For output, touch screen display 708 is a display device used to present information (e.g., text, video, graphics or other visible content) to the user of mobile device 706. Processor 710 controls visible display output on the LCD or other display element of the touch screen display 708 via a display driver 730, to present the various visible outputs to the device user.

The microphone 720 and speaker 722 are communicatively coupled to a voice or audio encoder/decoder (vocoder) 732. For a voice telephone call, for example, the vocoder 732 provides two-way conversion between analog audio signals representing speech or other audio and digital samples at a compressed bit rate compatible with the digital protocol of wireless telephone network communications or voice over packet (e.g., Internet Protocol) communications. The vocoder, speaker and microphone may also be used as elements of the user interface during other operations of the device, including some types of transaction communications.

Also, as shown in FIG. 7, the mobile device 706 includes at least one transceiver 734 (labeled XCVR in the figure) and an associated antenna 736, which may be a digital transceiver for digital wireless communications via a wide area wireless mobile communication network, although the mobile device 706 may include additional digital or analog transceivers (not shown). The transceiver 734 conforms to one or more of the various digital wireless communication standards utilized by modern mobile networks. Examples of such transceivers include (but are not limited to) transceivers operable to operate in accordance with Code Division Multiple Access (CDMA) and 3rd Generation Partnership Project (3GPP) network technologies including, for example and without limitation, 3GPP type 2 (or 3GPP2) and 3GPP Long Term Evolution (LTE) (or “4G”), fifth generation wireless (5G). For example, transceiver 734 provides two-way wireless communication of information including digitized audio signals, still image and/or video signals, web page information for display as well as web related inputs, and various types of mobile message communications to/from the mobile device 706. Transceiver 734 may also support various types of mobile messaging services, such as short message service (SMS), enhanced messaging service (EMS), and/or multimedia messaging service (MMS).

In an example, the transceiver 734 may be coupled to the processor 710 and operable to exchange communications. The processor 710 of the mobile device 706 may be further operable to perform additional functions, including functions to establish, using the transceiver, a connection with a server or entity, such as the authentication server 116 and insurance provider 122, to exchange communications. Via the connection with the server or insurance provider, the mobile device 706 may be able to obtain various information, such as authentication information, insured object information, user information, and the like. The processor upon execution of the authentication app 704 and the insurance app 728 may implement the examples as discussed above with reference to FIGS. 1-5.

The mobile device 706 may also include a Wi-Fi transceiver 740 and associated Wi-fi antenna 738. Although Wi-Fi is used here as the example, the transceiver 740 may take the form of any available two-way wireless local area network transceiver of a type that is compatible with one or more standard protocols of communication implemented in wireless local area networks, such as one of the Wi-Fi standards under IEEE 802.11 and/or WiMAX.

Alternatively, or in addition, applications may be stored in secure element (SE) storage 742, which may be a solid-state memory storage or other memory device suitable for storing applications. In one example, the secure element storage 742 may be a separate chip that includes tamperproof storage and execution memory and is operable to communicate with operating system. The secure element storage 742 may, for example, store an instance of an authentication app 704 for processing receipt data, communicating with one or more services or servers, and processes as described with reference to the examples of FIGS. 1-3. Other applications such as authentication app 704 and 728 may also be stored in secure element storage 742.

The mobile device 706 may also include a near-field communication device 746 that is coupled to the secure element storage 742 and the processor 710. As discussed in the earlier examples, the authentication app 704 and the insurance app 728, when executed by the processor 710, may be operable to control the near-field communication device 746 and receive signals from the user identifier apparatus 702, which may be implemented as the contactless card 106, credential apparatus 330, or contactless card 402. Details of the user identifier apparatus 702 may be obtained from the earlier discussion of those devices. As explained above, the contactless card 402 when implemented as the user identifier apparatus 702, may be built on a software platform operable on smart cards or other devices having limited memory, such as JavaCard, and one or more or more applications or applets may be securely executed. Applets may be added to contactless cards to provide authentication in various mobile application-based use cases, such as the above described claim processing authentication case. Applets may be configured to respond to one or more requests, such as near field data exchange requests, from an application, such as authentication app 704 or insurance app 728, such that the mobile NFC reader (e.g., the near-field communication device 746 of the mobile device 706), is operable to receive or produce an NDEF message that comprises a cryptographically secure payload encoded as an NDEF message.

In the example, the near-field communication device 746 may include an NFC controller 748, NFC transceiver 750 and an NFC antenna 752. The NFC controller 748 may initiate contact with the user identifier apparatus 702 according to known NFC communication protocols and cause the NFC transceiver 750 to transmit signals and receive signals via the NFC antenna 752 to establish communications with the user identifier apparatus 702. The insurance app 728 may process the signals received from the user identifier apparatus 702 as described above with reference to the examples of FIGS. 1-5. As described in the example of FIG. 3, the authentication app 704 may process the received signals.

The logic implemented by the processor 710 of the mobile device 706 configures the processor 710 to control various functions as implemented by the mobile device 706. The logic for a processor may be implemented in a variety of ways, but in the presented examples, the processor logic is implemented by programming for execution by the processor 710.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure be limited not by this detailed description, but rather by the claims appended hereto. Future filed applications claiming priority to this application may claim the disclosed subject matter in a different manner and may generally include any set of one or more limitations as variously disclosed or otherwise demonstrated herein.

What is claimed is:

1. A computing apparatus comprising:
a processor; and
a memory storing instructions and an insurance provider application that, when the insurance provider application is executed by the processor, the computing apparatus is operable to:
receive a claim request message via a user input related to an insured object of a user, wherein the claim request message is a message that includes insured object information;
obtain, via a reading of a user identifier apparatus by a near-field communication circuit, information enabling authentication of the user as being associated with the insured object, wherein the obtained information from the reading of the user identifier apparatus includes a reference link to an authentication application and multiple parameters;
retrieve state information related to the insured object and a mobile device associated with the insured object;
send a request, by using the reference link, to authenticate the user of the insured object to the authentication application, wherein the request includes one or more of the multiple parameters;
receive confirmation that the retrieved state information corresponds to identifying information corresponding to the insured object;
evaluate the retrieved state information and a response to the request for the authentication; and
based on a result of the evaluation, proceed with processing of the claim request message by the insurance provider application.

2. The computing apparatus of claim 1, wherein the insurance provider application, when executed by the processor to retrieve the state information related to the insured object and the mobile device associated with the insured object, the computing apparatus is further operable to:
obtain location information of the mobile device; and
confirm the obtained location information of the mobile device corresponds to a location of the insured object including one or more of: a location of the insured object set in the insurance provider application, a mapping application, or a publicly-available sales record.

3. The computing apparatus of claim 1, wherein the claim request message includes information related to a loss sustained by the user.

4. The computing apparatus of claim 1, further comprising:
a display coupled to the processor, wherein the insurance provider application when executed by the processor further cause the computing apparatus to:
upon receipt of the claim request message, cause presentation of a prompt on the display requesting that a user identifier device be read via the near-field communication circuit.

5. The computing apparatus of claim 1, wherein the multiple parameters include a version number related to the user identifier apparatus, a unique identifier of the user, an application transaction counter, a one-time password, or a cryptogram usable to validate the claim request as legitimate.

6. The computing apparatus of claim 1, wherein the retrieved state information includes GPS location information, information related to a wireless communication link between the insured object and the mobile device, and status of safety or security equipment.

7. The computing apparatus of claim 6, wherein the insurance provider application when executed by the processor further cause the computing apparatus to:
forward an application programming interface call from the insurance provider application to an operating system of the mobile device;
receive communication link information related to a communication link between the mobile device and the insured object from the operating system of the mobile device; and
maintain the communication link information as part of the state information, wherein the communication link information is the reference link.

8. The computing apparatus of claim 1, wherein the insurance provider application, when executed by the processor to retrieve the state information related to the insured object and the mobile device associated with the insured object, cause the computing apparatus to:
obtain from the claim request message an internet protocol address associated with the insured object, wherein the insured object is a residence;
review interaction history of the user with the insurance provider application to locate the internet protocol address in the insured object information;
analyze a result of the reviewing to determine whether the internet protocol address is an internet protocol address most frequently associated with user interactions by the user with the insurance provider application; and
provide an indication that the internet protocol address in the retrieved state information is the internet protocol address most frequently associated with the user interactions by the user with the insurance provider application.

9. A non-transitory computer-readable storage medium, the computer-readable storage medium including instructions that when executed by a processor, cause the processor to:
receive, by an insurance provider application, a claim request message via a user input related to an insured object of a user, wherein the claim request message is a message that includes insured object information;
obtain, via a reading of a user identifier apparatus by a near-field communication circuit, information enabling authentication of the user as being associated with the insured object, wherein information obtained from the reading of the user identifier apparatus includes a reference link to an authentication application and multiple parameters;
retrieve state information related to the insured object and a mobile device associated with the insured object;
send a request, by using the reference link, to authenticate the user of the insured object to the authentication application, where the request includes one or more of the multiple parameters;
receive confirmation that the retrieved state information matches to information identifying the insured object;
evaluate the retrieved state information and a response to the request for the authentication; and
based on a result of the evaluation, proceed with processing of the claim request message by the insurance provider application.

10. The non-transitory computer-readable storage medium of claim 9, wherein the instructions further configure the processor to:
upon receipt of the claim request message, presenting a prompt, on a display coupled to the insurance provider application, requesting that a user identifier device be read via a near-field communication circuit of a mobile device execute the insurance provider application.

11. The non-transitory computer-readable storage medium of claim 9, wherein the multiple parameters include a version number, a unique identifier of the user, an application transaction counter, a one-time password, or a cryptogram usable to validate the claim request as legitimate.

12. The non-transitory computer-readable storage medium of claim 9, wherein the retrieved state information includes GPS location information, a wireless communication link between the insured object and the mobile device, and/or safety or security equipment status.

13. The non-transitory computer-readable storage medium of claim 9, wherein the retrieving state information related to the insured object and the mobile device associated with the insured object, includes:
obtain from the claim request message an internet protocol address included associated with the insured object, wherein the insured object is a residence;
review interaction history of the user with the insurance provider application to locate the internet protocol address in the insured object information;
analyze a result of the reviewing to determine whether the internet protocol address is the internet protocol address most frequently associated with user interactions by the user with the insurance provider application; and
provide an indication that the internet protocol address is the internet protocol address most frequently associated with the user interactions by the user with the insurance provider application.

14. The non-transitory computer-readable storage medium of claim 9, wherein the retrieving state information related to the insured object and the mobile device associated with the insured object, includes:
obtain location information of the mobile device;
confirm the obtained location information of the mobile device corresponds to a location of the insured object including one or more of: a location of the insured object set in the insurance provider application, a mapping application, or a publicly-available sales record.

15. A method, comprising:
receiving, by an insurance provider application, a claim request message via a user input related to an insured object of a user, wherein the claim request message is a message that includes insured object information;
obtaining, via a reading of a user identifier apparatus by a near-field communication circuit, information enabling authentication of the user as being associated with the insured object, wherein the information obtained from the reading of the user identifier apparatus includes a reference link to an authentication application and multiple parameters;
retrieving state information related to the insured object and a mobile device associated with the insured object;
sending, by using the reference link, a request for authentication of the user of the insured object to the authentication application, wherein the request includes on one or more of the multiple parameters;
receiving a confirmation of the retrieved state information that the retrieved state information corresponds to identifying information corresponding to the insured object;
evaluating the confirmation of the retrieved state information and a response to the request for the authentication; and
based on a result of the evaluation, proceeding with processing of the claim request message by the insurance provider application.

16. The method of claim 15, wherein the claim request message includes information related to a loss sustained by the user.

17. The method of claim 15, further comprising:
upon receipt of the claim request message, presenting a prompt, on a display coupled to the insurance provider application, requesting that a user identifier device be read via a near-field communication circuit of a mobile device executing the insurance provider application.

18. The method of claim 15, wherein:
the multiple parameters include a version number, a unique identifier of the user, an application transaction counter, a one-time password, or a cryptogram usable to validate the claim request as legitimate; and
the retrieved state information includes GPS location information, a wireless communication link identifier between the insured object and the mobile device, or safety or security equipment status.

19. The method of claim 15, wherein the retrieving state information related to the insured object and the mobile device associated with the insured object, includes:
obtaining from the claim request message an internet protocol address included associated with the insured object, wherein the insured object is a residence;
reviewing interaction history of the user with the insurance provider application to locate the internet protocol address in the insured object information;
analyzing a result of the reviewing to determine whether the internet protocol address is an internet protocol address most frequently associated with user interactions by the user with the insurance provider application; and
providing an indication that the internet protocol address is the internet protocol address most frequently associated with the user interactions by the user with the insurance provider application.

20. The method of claim 15, wherein the retrieving state information related to the insured object and the mobile device associated with the insured object, includes:
obtaining location information of the mobile device; and
confirming the obtained location information corresponds to a location of the insured object that corresponds with one or more of: a location of the insured object set in the insurance provider application, a mapping application, or a publicly-available sales record.
